(19) United States
(12) Patent Application Publication
(10) Pub. No.: US 2012/0286512 A1
(43) Pub. Date: Nov. 15, 2012

(54) ELECTRICITY PRODUCTION SYSTEM

(75) Inventor: Hervé Biellmann, Eloie (FR)

(73) Assignee: GE Energy Products France SNC, Belfort (FR)

(21) Appl. No.: 13/331,507

(22) Filed: Dec. 20, 2011

(30) Foreign Application Priority Data
Dec. 21, 2010 (FR) 1060955

(51) Int. Cl. F02N 11/08

(52) U.S. Cl. 290/46

(57) ABSTRACT

Electricity production system comprising:
an alternator (G) comprising a rotor and a stator;
a means for driving the rotor (T);
said alternator having a first operating mode, called alternator mode, in which the rotor is driven by the rotor driving means and the alternator supplies electricity and a second operating mode, called motor mode, in which the alternator is powered with electricity and the rotor supplies a motive mechanical force;
a conversion means (MC) capable of powering the alternator in motor mode with a frequency which varies so that the rotor reaches a certain rotation speed; and
at least one auxiliary electric equipment item (M).

The conversion means comprises, for each of the auxiliary electric equipment items, a voltage converter (CT) capable of powering said auxiliary equipment item, a section of the voltage converters of all the auxiliary equipment items being capable of jointly powering the alternator in motor mode.

### RELATED APPLICATION

This application claims priority to French application Ser. No. FR 10 60955, filed Dec. 21, 2010, the entire disclosure of which is incorporated herein by this reference.

The invention belongs to the technical field of alternators. It applies in particular to the turbines and the auxiliaries of electrical energy producing power stations.

When a power station is started up, it is known to use an alternator in motor mode by powering it from a convertor, in order to drive in rotation the shaft line of the turbine and of the alternator. It is also known to use a converter for powering auxiliary equipment items such as pump motors.

Currently, two different types of converter are normally used, namely a voltage converter to power auxiliary equipment items (for example a motor) and a current converter to start up the alternator. If one of the two converters fails, then respectively the alternator or the auxiliary equipment item cannot operate. In the case where there are many auxiliary equipment items to be powered, as many converters have to be used as there are auxiliary equipment items and a separate converter must also be provided to start up the alternator. Each of these converters has a cost and a bulk on the ground which are relatively significant, whereas the equipment items that use them, notably the alternator in motor mode, and the auxiliary equipment items are not always used simultaneously.

There is therefore a need to reduce the number of converters to be used in a power station, dedicated to the alternator and to the auxiliary equipment items.

There is also a need to increase the reliability of the conversion implemented by the converters.

The invention sets out to resolve all or some of the problems stated above.

According to one embodiment, an electricity production system is proposed, comprising:
an alternator, for example a synchronous alternator, comprising a rotor and a stator;
a means for driving the rotor, for example a gas turbine;
said alternator having a first operating mode, called alternator mode, in which the rotor is driven by the rotor driving means and the alternator supplies electricity and a second operating mode, called motor mode, in which the alternator is powered with electricity and the rotor supplies a motive mechanical force;
a conversion means capable of powering the alternator in motor mode with a frequency which varies so that the rotor reaches a certain rotation speed; and
at least one auxiliary electric equipment item, for example at least one asynchronous motor.

According to a general characteristic of this electricity production system, the conversion means comprises, for each of the auxiliary electric equipment items, a voltage converter capable of powering said auxiliary equipment item, a section of the voltage converters of all the auxiliary equipment items being capable of jointly powering the alternator in motor mode.

Thus, since the converter of the alternator is a voltage converter, it can be used to power any auxiliary equipment item and in particular an asynchronous motor. This is advantageous because the asynchronous motors are, for one and the same power, less expensive than the synchronous motors. In the case of a single auxiliary equipment item, only one converter is then necessary to be able to power the alternator and the auxiliary equipment item. In all cases, a converter can be eliminated while all the auxiliary equipment items can continue to be powered simultaneously. The total power of the installed converters can thus be reduced.

According to another embodiment, the system comprises a single auxiliary electric equipment item and a conduction means comprising a first branch linking the voltage converter to the alternator and a second branch linking the voltage converter to said auxiliary electric equipment item, each of the two branches including an isolating member so as to alternately power the alternator in motor mode and said auxiliary electric equipment item with the voltage converter.

Outside the alternator shaft line start-up phase, the voltage converter is not used by the alternator and can therefore be used to power an auxiliary equipment item by switching over the isolating member.

According to one embodiment, the system comprises a power supply means for powering the conversion means, said at least one auxiliary electric equipment item also being linked to the power supply means so that the at least one auxiliary electric equipment item is powered alternately with the conversion means and with the power supply means.

The auxiliary equipment items are powered alternately by the converters and the power supply means. They can be powered directly by the power supply means without the use of the converters. Thus, the availability of the converters with regard to the alternator increases. Furthermore, the auxiliary equipment items can operate even if the converters are used to start up the alternator in motor mode.

According to another characteristic of the invention, said voltage converters are placed in parallel in the conversion means and the sum of the electric powers of said converters is greater than or equal to the power to start up the alternator in motor mode up to its nominal speed.

In the case where a number of equipment items are used, it is not necessary for each of the converters to be able to power the alternator in motor mode. It is sufficient for all the converters to be able to power the alternator in motor mode. For this, an architecture is advantageously used whereby the voltage converters which behave as voltage sources are placed in parallel so that the power supplied by all the converters is then the sum of all the powers of the converters. It is then no longer necessary to have any converter with a great power rating to start up the shaft line when a number of auxiliary equipment items are present in the electricity production system.

According to yet another characteristic, the conversion means also comprises at least one additional voltage converter, said additional voltage converter being linked by conduction means to the alternator in motor mode and/or to at least one of the auxiliary electric equipment items so as to allow for a redundancy of the power supply for the alternator and/or the auxiliary equipment items.

By adding an additional voltage converter, an additional power supply means is obtained which can mitigate any faults in the other voltage converters. Thus, the reliability of the conversion means and the availability of the auxiliary equipment items and of the alternator are increased. With this or these additional converter(s) it is also possible to power the auxiliary equipment items and the alternator simultaneously.

According to another embodiment, the gas turbine is a microturbine.

According to another embodiment, the rotor driving means is a heat engine.

Other features and advantages of the invention will become apparent on studying the detailed description of implementations and embodiments, which are in no way limiting, and the appended drawings in which:

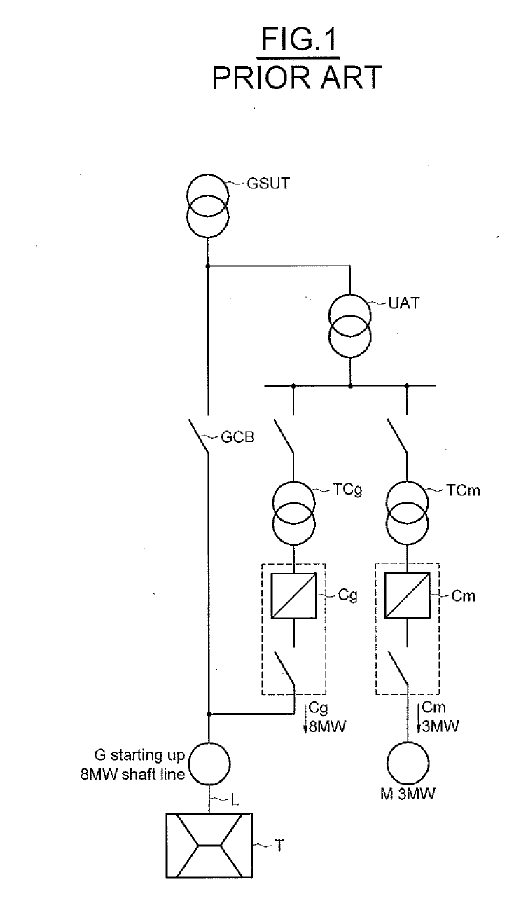

FIG. 1 schematically illustrates an example of an alternator with an auxiliary equipment item according to the prior art;

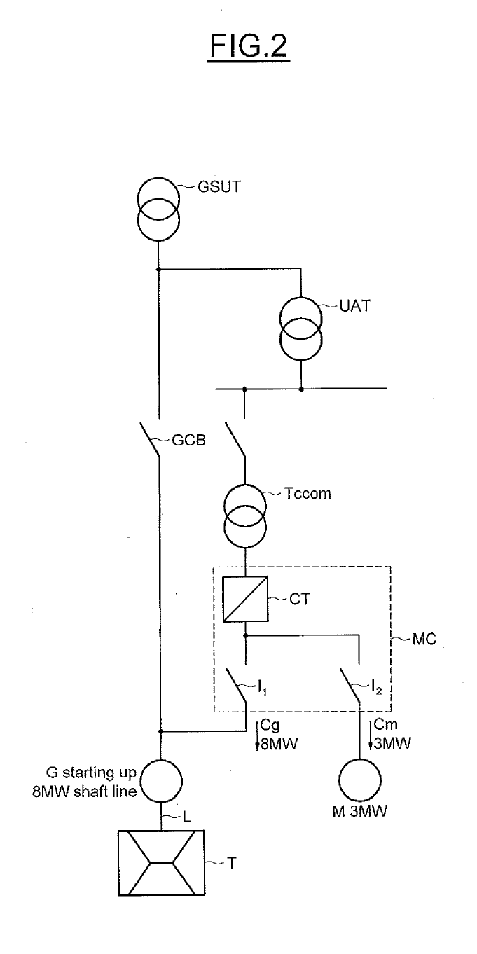

FIG. 2 illustrates a power supply and start-up stage according to the invention;

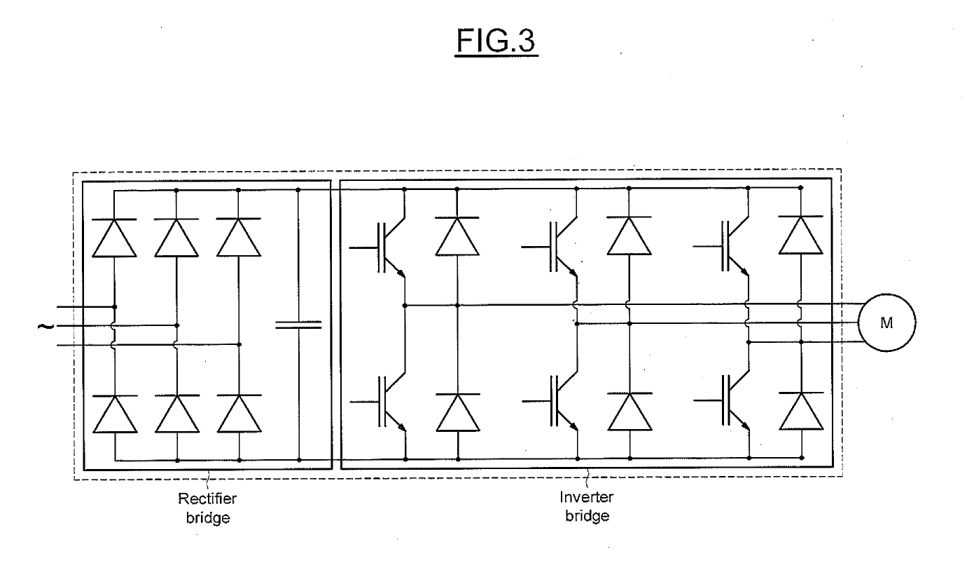

FIG. 3 illustrates an embodiment of a converter for a power supply and start-up stage according to the invention; and

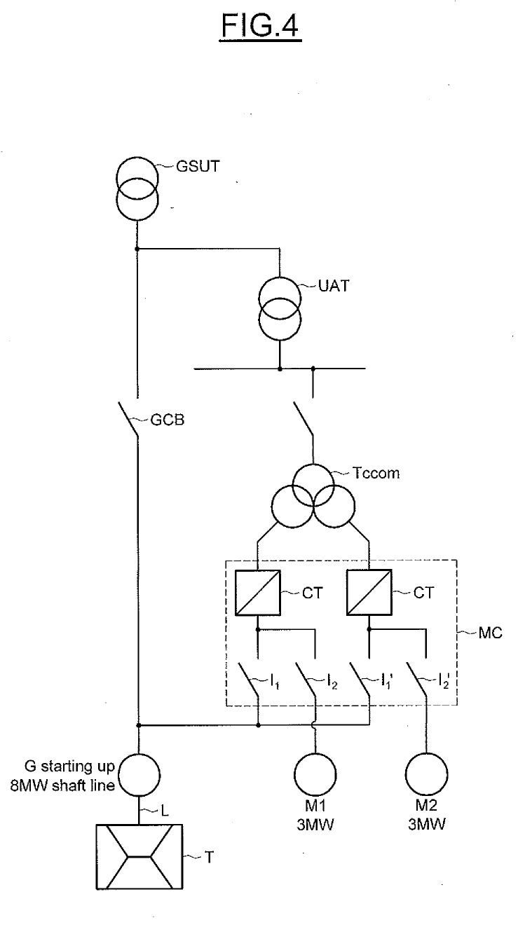

FIG. 4 shows a variant of a power supply and start-up stage with a number of auxiliary equipment items.

FIG. 1 illustrates an electricity production system according to the prior art and, in particular, its power supply and start-up stage. It comprises an alternator G, for example a synchronous alternator, and a set transformer GSUT. The alternator G comprises a rotor and a stator. The alternator G can operate either in an alternator mode, in which it produces electricity when the rotor is driven, or in a motor mode, to start up the turbine. In alternator mode, the rotor is driven by a driving means T, for example a gas turbine, via a shaft line L and the alternator thus supplies energy to the electricity network via the set transformer GSUT. The link between the alternator G and the set transformer GSUT also comprises a set circuit breaker GCB which makes it possible to cut the transmission of the current produced by the alternator.

In the case, for example, where the rotor is driven by a gas turbine, the rotation speed is then very high, around several thousand revolutions per minute (from 2000 to 3000 rpm). Thus, on start up, the alternator is first of all used in motor mode so as to drive the rotor up to a sufficient rotation speed VS, that is to say, a rotation speed for it to be able to be driven by the turbine. For example, VS is equal to 1500 rpm.

The electricity production system also comprises a current converter Cg (or current source type voltage converter), the function of which is to supply the alternator in motor mode with current so that the rotor reaches a sufficient rotation speed. The current converter Cg supplies an electric current, the frequency of which progressively increases so as to progressively increase the rotation speed of the rotor until the sufficient rotation speed VS is obtained. According to the prior art, the current converter Cg used in these applications is usually a current inverter comprising a thyristor current rectifier and an inductance.

The current converter Cg is powered by the transformer TCg, which is in turn powered by the transformer UAT. The current converter also comprises a circuit breaker represented by a switch in FIG. 1. The part downstream of the transformer UAT, the alternator side, is secured by means of a circuit breaker between the transformers UAT and Teg represented in FIG. 1 by a switch.

As can be seen, the electricity production system also comprises an auxiliary equipment item. For example, the auxiliary equipment item M is an asynchronous motor. The motor M which requires a power of a few megawatts is powered by the converter Cm, which is in turn powered by the transformer TCm, linked to the transformer UAT. The part downstream of the transformer UAT, on the auxiliary equipment item side, is protected by means of a circuit breaker between the transformers UAT and TCm represented by a switch in FIG. 1. The converter Cm is, by way of exemplary embodiment, a voltage converter with a power of around a few megawatts, corresponding to the needs of the auxiliary equipment item.

As indicated previously, this type of arrangement requi-res the provision of a converter dedicated to powering the alternator, on starting up the turbine, and a converter for each auxiliary equipment item.

FIG. 2 shows the architecture of an electricity production system provided with a conversion means MC according to the invention that makes it possible to mitigate this drawback. The rotor driving means T of FIG. 2 may be a gas turbine, or any other mechanical energy source, for example a micro turbine or a heat engine, for example a diesel engine. The conversion means MC comprises a single voltage converter CT associated with a conduction means, for example an electric cabling or a bus, linking the voltage converter CT (or voltage source converter) to the alternator G and to an auxiliary equipment item M. The conversion means MC is powered by a power supply means Tccom, for example a transformer, which is in turn powered by the transformer UAT. The power supply means Tccom could also be directly an electricity network. The conduction means comprises two branches, one linking the voltage converter to the alternator G and the other linking the voltage converter to the auxiliary equipment item M which is, according to one embodiment, an asynchronous motor. The auxiliary equipment item could also be a heating resistance or any other type of electricity-consuming equipment.

Advantageously, the converter CT is capable of powering the alternator in motor mode as well as the electric equipment item. For this, a voltage inverter is advantageously used which comprises a voltage rectifier which will be explained hereinbelow. A conventional current converter, such as the converter Cg described previously, could not be used to power any auxiliary equipment item and in particular an asynchronous motor M. In fact, by construction, a current converter Cg comprising, for example, thyristor bridges can effectively power only synchronous machines. Thus, with the voltage converter CT, by varying the frequency, the alternator G is powered in motor mode so that its rotor reaches a sufficient rotation speed VS, that is to say, a rotation speed for it to be able to be driven by the driving means.

Moreover, each of the two branches includes an isolating member I1 and I2, the state of which can be blocked or passing. As an exemplary embodiment, the isolating member is a circuit breaker, a main isolator, or a switch. The state of the isolating member of the first branch is different from that of the isolating member of the second branch. Thus, the alternator in motor mode and the motor are powered selectively and alternately by the converter CT.

FIG. 3 illustrates an exemplary embodiment of a voltage converter CT (or voltage source converter) of the stage of FIG. 2. It comprises:
a three-phase diode rectifier bridge associated with a capacitor forming a DC voltage source.
an inverter bridge powered by a DC voltage which generates an alternating voltage wave with amplitude and frequency that can be varied by the pulse width modulation (PWM) technique which is well known to those skilled in the art. An IGBT (insulated gate bipolar transistor) inverter bridge could be used. As a variant, an IGCT (integrated gate commutated thyristor) inverter'bridge could also be used.
a control unit supplying conduction commands to the inverter bridge according to setpoints, such as the ramp of the rotor rotation speed, the maximum torque, etc.

A voltage converter as described above has the advantage of being able to supply a sufficient power to power, on its own, the alternator in motor mode (of the order of ten or so MW). Furthermore, unlike the converter Cg, it is a voltage converter (voltage source converter), so it can be used without preference to power synchronous or asynchronous equipment items, such as, for example, an asynchronous motor and a synchronous alternator.

FIG. 4 illustrates an embodiment of the power supply and start-up stage in the case where the electricity production system comprises a number of auxiliary equipment items.

The power supply means Tccom is linked to the conversion means MC which powers a first and a second auxiliary equipment item M1 and M2, which are, for example, two asynchronous motors.

The conversion means MC here comprises two voltage converters CT, a first dedicated to the auxiliary equipment item M1 and to the alternator in motor mode, and a second dedicated to the auxiliary equipment item M2 and to the alternator in motor mode. The first and the second converters CT are linked to the alternator G, and to the first and second auxiliary equipment items by conduction means.

The conduction means may be, for example, buses or electric cablings.

The first converter is linked by a first branch of a first conduction means to the alternator, for its power supply in motor mode, and by a second branch of the first conduction means to the auxiliary equipment item M1. The second converter is linked by a first branch of a second conduction means to the alternator and by a second branch of the second conduction means to the auxiliary equipment item M2. Each of the four branches includes an isolating member I1, I2, I1′, I2′ having a blocked or passing state. As an exemplary embodiment, the isolating member is a circuit breaker, a main isolator or a switch. The isolating members are controlled to that the conversion means can operate in two modes:
a first mode in which the first converter powers the first auxiliary equipment item M1 and the second converter powers the second auxiliary equipment item M2, the isolating members I2 and I2′ of the second branch of the first and of the second conduction means being passing.
a second mode in which the first converter powers the alternator G in motor mode and the second converter powers the alternator G in motor mode, the isolating members I1 and I1′ of the first branch of the first and of the second conduction means being passing.

In a variant, in addition to these first two modes, the conversion means MC can also operate in other modes. For example, a third mode in which all the isolating members I1, I2, I1′ and I2′ could be passing or a fourth mode in which all the isolating members I1, I2, I1′ and I2′ could be blocked. The isolating members of the first conduction means I1 and I2 or those of the second conduction means and I2′ could all be open or all closed respectively in a fifth or a sixth mode. An advantageous seventh mode may consist, for example, in powering one of the auxiliary equipment items M1 or M2 by means of one of the two voltage converters CT while retaining the power supply for the alternator by the other voltage converter CT (I1 and I2′ closed or I2 and I1′ closed).

When the conversion means MC is in the second mode, because of the use of two voltage converters CT (or voltage source converter) in parallel, the power supplied by the two converters is added together. To power the alternator in motor mode, it is therefore simply necessary for the sum of the powers of the converters to be greater than the power required for the alternator in motor mode. Thus, the voltage converters are used separately to power the auxiliary equipment items (M) and all the voltage converters are used jointly to power the alternator in motor mode.

According to a variant, the sum of the powers of a section of all the converters is greater than the power required to power the alternator in motor mode. Then, only a section of the voltage converters can be used to jointly power the alternator in motor mode.

A simple numerical application shows the power gain that is thus produced:
the normal start-up of the alternator in motor mode requires 8 MW
each of the two auxiliary equipment items requires 3 MW.

In the case of a dedicated converter for each equipment item, it is then necessary to count a necessary electric power of 14 MW (2×3+8=14).

In the case of a conversion means comprising voltage converters according to the invention, then only two 4 MW converters are sufficient. They can be used separately to power the two auxiliary equipment items (3 MW<4 MW) and they can be used jointly to power the alternator (8 MW=2×4 MW). A saving of almost 6 MW (14 MW−8 MW) is thus obtained for the total power of the converters.

The start-up of a shaft line as illustrated in FIG. 4 comprises, in the case of drive by a gas turbine, a number of phases:
a first phase in which the shaft line is driven in rotation by the rotor of the alternator, the alternator being powered by the conversion means MC in motor mode;
a second phase in which the rotation speed of the shaft line reaches the value VS (for example 1500 rpm), the shaft line being driven by the rotor driving means and by the rotor of the alternator. The power supply of the alternator in motor mode continues.
a third phase in which, when the shaft line and the alternator reach a nominal speed VN (for example 2500 rpm), the power supply of the alternator by the conversion means can be stopped.

During this start-up, if the motor torque supplied by the turbine is disregarded, the speed ramp-up of the shaft line is approximately governed by the following equation:

Cmo−Cr=J*dN/dt
with:
   Cmo: motor torque (torque supplied by the alternator driven in motor mode)
   Cr: resisting torque of all the machines forming the shaft line
   J: inertia of all the machines forming the shaft line
   N: rotation speed of the shaft line
   t: time

From the moment that the motor torque Cmo remains greater than the resisting torque Cr, the start-up of the shaft line is guaranteed.

Usually, the power needed to start up a shaft line is engineered according to the resisting torque, the nominal rotation speed VN and a start-up period.

That said, a lower motor torque Cmo could also be used, provided that it remains greater than the resisting torque Cr. This operating mode corresponds to a longer start-up.

Thus, given that the resisting torque Cr increases with the rotation speed N, it may be possible, with a lower motor torque Cmo, to start up the shaft line with a lower speed, therefore a lower power, if a longer start-up time is accepted.

For example, in the case of a gas turbine, the trend of the resisting torque Cr approximately follows the square of the rotation speed N, and the trend of the corresponding power therefore follows the cube of the rotation speed.

Thus, for a rotation speed 20% less than the rotation speed VN, the motor power corresponding to the resisting torque Cr at this speed is divided by two (the multiplication 0.8×0.8×0.8 is approximately equal to 0.5).

Thus, in the case of the numerical application described previously, it is possible, with a rotation speed equal to 80% of the speed VN, to start up the shaft line with a power divided by two. In fact, this rotation speed of 80% of the speed VN is greater than the speed VS (0.8×2500=2000 rpm>1500 rpm).

It can therefore be seen that, in the above example, when one of the two voltage converters fails (4 MW power supplied instead of 8 MW), it nevertheless remains possible to start up the alternator in motor mode.

This invention therefore makes it possible, on the one hand, to reduce the total power of the converters needed to start up the alternator in motor mode and to drive the two auxiliary equipment items.

It may, on the other hand, make it possible to have, with no extra cost (either in terms of converter power or finance), a redundant start-up system making it possible to start up the alternator in motor mode should one power conversion module fail. Finally, it makes it possible to maintain the start-up of the alternator and simultaneously the power supply for an auxiliary by using only a section of the voltage converters to power the alternator. For example, in the seventh operating mode of the converter described previously, the power supply for an auxiliary and the start-up of the alternator are simultaneously assured by means of a single voltage converter to power the alternator.

According to another alternative, it is possible to add additional voltage converters in the conversion means MC linked to at least one auxiliary equipment item and/or to the alternator. These voltage converters are said to be additional inasmuch as they are added to the voltage converters that the conversion means already includes for each auxiliary equipment item. For example, in the case of two auxiliary equipment items, if there are three voltage converters, then one voltage converter is additional.

Such an arrangement is advantageous because the additional converters can be added to the power of the other voltage converters and can take over to power an auxiliary equipment item or the alternator in motor mode. In other words, this makes it possible to provide a redundancy for the two systems (start-up of the alternator in motor mode and power supply for the auxiliary equipment items). According to the prior art, it would have been necessary to add a spare module for each system.

Furthermore, by using at least one additional converter linked to at least one auxiliary equipment item and to the alternator, it may be possible to start up all the auxiliary equipment items and the alternator in motor mode, simultaneously. A reduced saving on the total electric power of the converters is observed. On the other hand, as in the case indicated above, it is possible to obtain a redundancy for the two systems (start-up of the alternator in motor mode and power supply for the auxiliary equipment items).

1. An electricity production system comprising:
an alternator comprising a rotor and a stator;
a means for driving the rotor;
said alternator having a first operating mode, called alternator mode, in which the rotor is driven by the rotor driving means and the alternator supplies electricity and a second operating mode, called motor mode, in which the alternator is powered with electricity and the rotor supplies a motive mechanical force;
a conversion means capable of powering the alternator in motor mode with a frequency which varies so that the rotor reaches a certain rotation speed; and
at least one auxiliary electric equipment item,
characterized in that the conversion means comprises, for each of the auxiliary electric equipment items, a voltage converter capable of powering said auxiliary equipment item, a section of the voltage converters of all the auxiliary equipment items being capable of jointly powering the alternator in motor mode.

2. The system according to claim 1, comprising a single auxiliary electric equipment item and a conduction means comprising a first branch linking the voltage converter to the alternator and a second branch linking the voltage converter to said auxiliary electric equipment item, each of the two branches including an isolating member so as to alternately power the alternator in motor mode and said auxiliary electric equipment item with the voltage converter.

3. The system according to claim 1, comprising a power supply means for powering the conversion means, said at least one auxiliary electric equipment item also being linked to the power supply means so that the at least one auxiliary electric equipment item is powered alternately with the conversion means and with the power supply means.

4. The system according to claim 1, in which said voltage converters are placed in parallel in the conversion means and the sum of the electric powers of said converters is greater than or equal to the power to start up the alternator in motor mode up to its nominal speed.

5. The system according to claim 1, in which the conversion means also comprises at least one additional voltage converter, said additional voltage converter being linked by conduction means to the alternator in motor mode so as to allow for a redundancy of the power supply for the alternator

6. The system according to claim 1, in which the auxiliary equipment items are asynchronous motors.

7. The system according to claim 1, in which the alternator is synchronous.

8. The system according to claim 1, in which the rotor driving means is a gas turbine.

9. The system according to claim 8, in which the gas turbine is a micro turbine.

10. The system according to claim 1, in which the rotor driving means is a heat engine.

11. The system according to claim 1, in which the conversion means also comprises at least one additional voltage converter, said additional voltage converter being linked by conduction means to the alternator in motor mode and to at least one of the auxiliary electric equipment items so as to allow for a redundancy of the power supply for the alternator and the auxiliary equipment items.

12. The system according to claim 1, in which the conversion means also comprises at least one additional voltage converter, said additional voltage converter being linked by conduction means to at least one of the auxiliary electric equipment items so as to allow for a redundancy of the power supply for the auxiliary equipment items.
